(19) United States
(12) Patent Application Publication
(10) Pub. No.: US 2014/0283506 A1
(43) Pub. Date: Sep. 25, 2014

(54) HEAT PIPE, COMPOSITE MATERIAL AND HEAT EXCHANGER

(71) Applicant: Hitachi Metals, Ltd., Tokyo (JP)

(72) Inventors: Kazuma KUROKI, Hitachinaka (JP); Hideyuki SAGAWA, Tokai-mura (JP); Hiromitsu KURODA, Hitachi (JP); Yukio SUZUKI, Mito (JP)

(73) Assignee: Hitachi Metals, Ltd., Tokyo (JP)

(21) Appl. No.: 14/163,481

(22) Filed: Jan. 24, 2014

(30) Foreign Application Priority Data
Mar. 22, 2013 (JP) 2013-059946

(51) Int. Cl. F28D 15/02; B32B 15/01; F01N 5/02

(52) U.S. Cl. CPC F28D 15/025; F01N 5/02; B32B 15/015
USPC 60/320; 165/104.21; 428/675

(57) ABSTRACT

A heat pipe includes a metal cylindrical body including a sealed storage space for storing water, a heat absorbing portion at one end portion of the cylindrical body to absorb heat by means of evaporation of the water, and a heat radiating portion at another end portion of the cylindrical body to radiate heat by means of condensation of steam generated by the evaporation. The cylindrical body includes a base material mainly including a stainless steel, a first metal layer mainly including a nickel and a second metal layer mainly including a copper, the first metal layer being formed on an inner surface of the base material and the second metal layer being formed on an inner surface of the first metal layer. The second metal layer is exposed to the storage space.

The present application is based on Japanese patent application No.2013-059946 filed on Mar. 22, 2013, the entire contents of which are incorporated herein by reference.

### BACKGROUND OF THE INVENTION

1. Field of the Invention

The invention relates to a heat pipe to exchange heat by means of evaporation and condensation of steam, a composite material for constructing the heat pipe, and an heat exchanger using the heat pipe.

2. Description of the Related Art

A heat pipe is known that is used for a vehicle etc. with an engine so as to heat an engine cooling water by using the heat of exhaust gas (See e.g. JP-A-2010-116622).

The heat pipe disclosed in JP-A-2010-116622 is formed of a stainless steel and has a cylindrical shape. A sealed storage space in the heat pipe is evacuated and a liquid-phase portion with liquid water and a space portion for storing steam are formed therein. The space portion is located above the liquid-phase portion. Water in the liquid-phase portion is converted into steam by heat of exhaust gas. Then, the steam moves upward, is cooled by the engine cooling water and is condensed, which results in that the heat of the exhaust gas is transferred to the engine cooling water which is thereby heated.

### SUMMARY OF THE INVENTION

Metals contained in stainless steel, such as chrome (Cr), are likely to be oxidized. Therefore, when temperature of the steam in the space portion becomes high, oxygen (O) contained in steam (H₂O) is bonded to such easily-oxidizable metals and forms an oxide, which causes oxidation of the surface of stainless steel and also produces hydrogen (H₂) as a gas. This hydrogen is not liquefied even if cooled. Therefore, if the high-temperature state continues, the space portion of the heat pipe is highly pressurized. Thus, it is necessary to increase a thickness of stainless steel so as to withstand such high pressure and this leads to a decrease in heat-exchange efficiency or an increase in cost and weight.

It is an object of the invention to provide a heat pipe that protects an inner surface thereof from being oxidized, as well as a composite material for the heat pipe and a heat exchanger using the heat pipe.

(1) According to one embodiment of the invention, a heat pipe comprises:

a metal cylindrical body comprising a sealed storage space for storing water;

a heat absorbing portion at one end portion of the cylindrical body to absorb heat by means of evaporation of the water; and

a heat radiating portion at another end portion of the cylindrical body to radiate heat by means of condensation of steam generated by the evaporation,

wherein the cylindrical body comprises a base material mainly comprising a stainless steel, a first metal layer mainly comprising a nickel and a second metal layer mainly comprising a copper, the first metal layer being formed on an inner surface of the base material and the second metal layer being formed on an inner surface of the first metal layer, and

wherein the second metal layer is exposed to the storage space.

In the above embodiment (1) of the invention, the following modifications and changes can be made.

(i) The second metal layer comprises a metal layer mainly comprising a copper.

(ii) The second metal layer comprises a metal layer mainly comprising a copper-nickel alloy.

(iii) The second metal layer comprises a metal layer formed by melting nickel and copper sheets together by heat, the nickel and copper sheets being pressure-welded to a stainless steel sheet to be the base material.

(2) According to another embodiment of the invention, a composite material for heat pipe comprises:

a base material mainly comprising a stainless steel;

a first metal layer mainly comprising a nickel and formed on the base material; and

a second metal layer mainly comprising a copper and formed on the first metal layer,

wherein the composite material is configured to be used for a heat pipe that comprises a metal cylindrical body comprising a sealed storage space for storing water,

a heat absorbing portion at one end portion of the cylindrical body to absorb heat by means of evaporation of the water, and a heat radiating portion at another end portion of the cylindrical body to radiate heat by means of condensation of steam generated by the evaporation.

(3) According to another embodiment of the invention, a heat exchanger comprises a plurality of ones of the heat pipe according to the above embodiment (1), wherein the plurality of ones of the heat pipe each comprise one end portion located inside an exhaust gas passage, another end portion located inside a cooling water passage, and water enclosed at the one end portion thereof.

### EFFECTS OF THE INVENTION

According to one embodiment of the invention, a heat pipe can be provided that protects an inner surface thereof from being oxidized, as well as a composite material for the heat pipe and a heat exchanger using the heat pipe.

### BRIEF DESCRIPTION OF THE DRAWINGS

Next, the present invention will be explained in more detail in conjunction with appended drawings, wherein:

FIGS. 1A and 1B show an example configuration of a heat pipe in a first embodiment and the periphery thereof, wherein FIG. 1A is a configuration diagram illustrating a vehicle and FIG. 1B is a configuration diagram illustrating a heat exchanger using the heat pipe;

FIGS. 2A and 2B show the heat pipe in the first embodiment, wherein FIG. 2A is a cross sectional view and FIG. 2B is an enlarged view of the section A in FIG. 2A;

FIGS. 3A and 3B show a manufacturing process of the heat pipe, wherein FIG. 3A is a cross sectional view showing a plate-like member before being formed into a cylindrical shape and FIG. 3B is a cross sectional view showing the plate-like member after being formed into a cylindrical base pipe;

FIGS. 4A to 4C show a manufacturing process of the heat pipe, wherein FIG. 4A is a cross sectional view showing the base pipe including a central axis and FIGS. 4B and 4C are cross sectional views showing a state that the base pipe shown in FIG. 4A is processed;

FIGS. 5A to 5D are EDX spectra showing results of steam oxidation test conducted on first to fourth samples; and

FIGS. 6A and 6B show a heat pipe in a second embodiment, wherein FIG. 6A is a cross sectional view showing the heat pipe including a central axis and FIG. 6B is an enlarged view of the section B in FIG. 6A.

### DETAILED DESCRIPTION OF THE PREFERRED EMBODIMENT

### First Embodiment

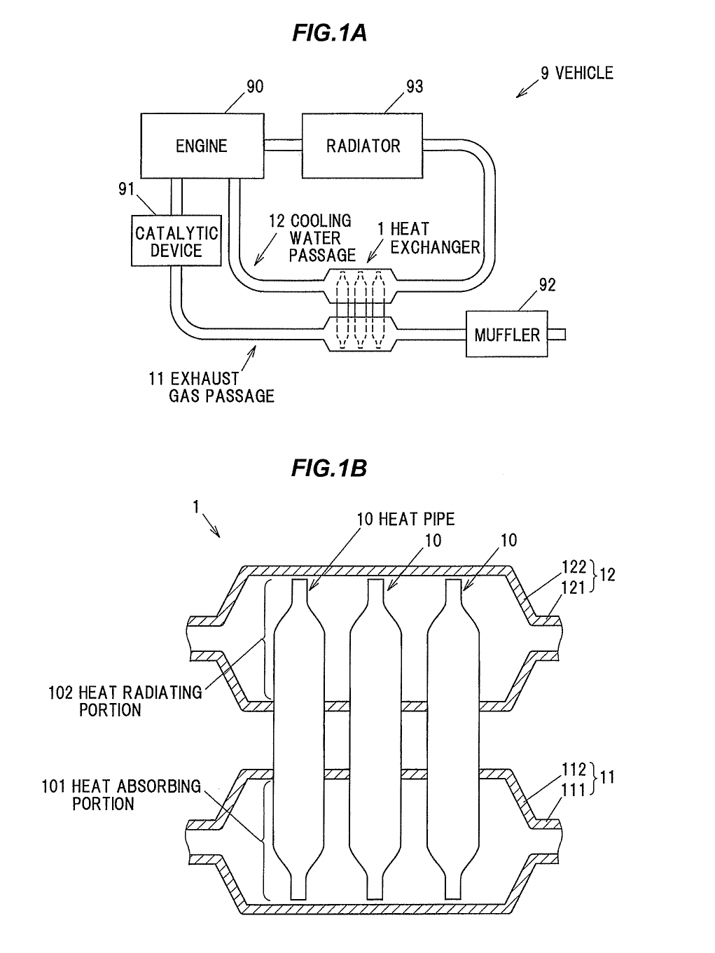

FIGS. 1A and 1B show an example configuration of a heat pipe in the first embodiment and the periphery thereof, wherein FIG. 1A is a configuration diagram illustrating a vehicle and FIG. 1B is a configuration diagram illustrating a heat exchanger using the heat pipe.

As shown in FIG. 1A, a vehicle 9 is provided with an engine 90 which is an internal combustion engine using a liquid fuel such as gasoline, a catalytic device 91 for cleaning exhaust gas from the engine 90, a muffler 92 for discharging the cleaned exhaust gas to the outside of the vehicle, and an exhaust gas passage 11 for providing a flow path of the exhaust gas. The vehicle 9 is also provided with a radiator 93 for cooling a cooling water for the engine 90, a cooling water passage 12 for providing a flow path of the cooling water, and a heat exchanger 1 interposed between the cooling water passage 12 and the exhaust gas passage 11 to perform heat exchange. It should be noted that illustrations of configuration, etc., of power train which drives wheels using a drive power of the engine 90 are omitted in the drawings.

The heat exchanger 1 heats up the cooling water for the engine 90 using heat of exhaust gas from the engine 90. This reduces the time until the cooling water reaches adequate temperature when, e.g., starting the engine 90 in a low temperature environment such as during the winter.

As shown in FIG. 1B, the heat exchanger 1 is composed of plural heat pipes 10 (three in the example shown in FIG. 1B). Each heat pipe 10 is constructed from a metal cylindrical body and a sealed storage space thereof contains liquid water (H₂O).

Each heat pipe 10 is arranged such that an end portion on the lower side in a vertical direction is located inside the exhaust gas passage 11 and another end portion on the upper side in the vertical direction is located inside the cooling water passage 12. Water is stored in the lower end portion of the heat pipe 10.

The exhaust gas passage 11 has a tubular pipe portion 111 and an expanded portion 112 formed to have a larger width in the vertical direction than that of the pipe portion 111. An end portion of the heat pipe 10 is placed inside the expanded portion 112. This end portion of the heat pipe 10 is exposed to exhaust gas from the engine 90.

The cooling water passage 12 has a tubular pipe portion 121 and an expanded portion 122 formed to have a larger width in the vertical direction than that of the pipe portion 121. Another end portion of the heat pipe 10 is placed inside the expanded portion 122. A cooling water for the engine 90 flows around the other end portion of the heat pipe 10.

The end portion of the heat pipe 10 placed in the expanded portion 112 of the exhaust gas passage 11 functions as a heat absorbing portion 101 for absorbing heat of exhaust gas. Meanwhile, the other end portion of the heat pipe 10 placed in the expanded portion 122 of the cooling water passage 12 functions as a heat radiating portion 102 for radiating the heat which is absorbed by the heat absorbing portion 101.

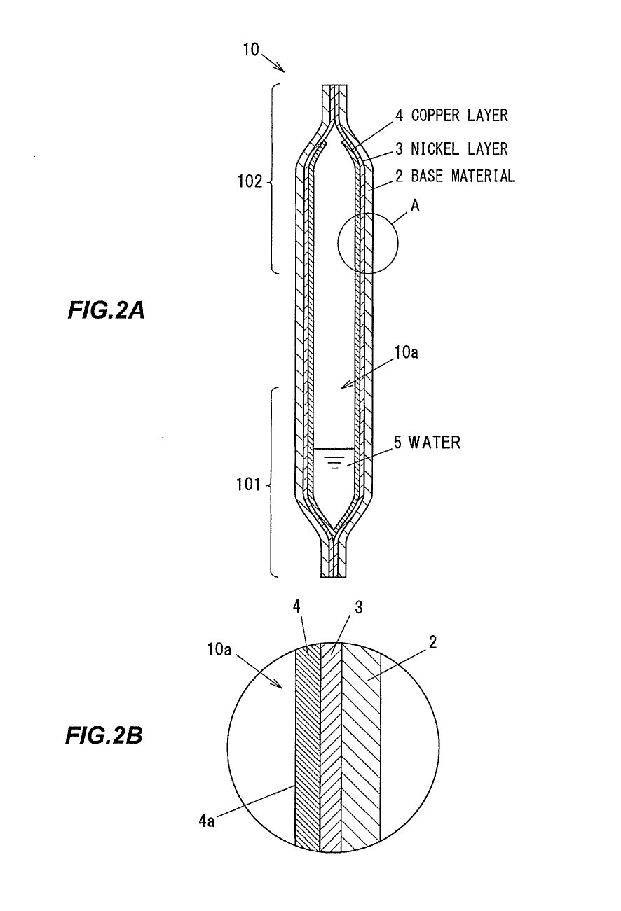

FIGS. 2A and 2B show the heat pipe 10, wherein FIG. 2A is a cross sectional view and FIG. 2B is an enlarged view of the section A in FIG. 2A.

The heat pipe 10 has a base material 2 consisting mainly of stainless steel, a nickel layer 3 as a first metal layer consisting mainly of nickel (Ni) and provided on an inner surface of the base material 2, and a copper layer 4 as a second metal layer consisting mainly of copper (Cu) and provided on an inner surface of the nickel layer 3. Both end portions of the heat pipe 10 each have a diameter reduced by swaging and are air-tightly closed by welding.

The heat pipe 10 has a sealed storage space 10a thereinside and a water 5 as a heat transfer liquid is stored in the storage space 10a. The water 5 is stored in the end portion of the heat pipe 10 serving as the heat absorbing portion 101. The storage space 10a is evacuated and decompressed. A surface 4a of the copper layer 4 is exposed in the storage space 10a.

The base material 2 has a thickness of, e.g., not less than 0.8 mm and not more than 1.0 mm. The nickel layer 3 has a thickness of, e.g., not less than 10 μm and not more than 15 μm. The copper layer 4 is thicker than the nickel layer 3 and has a thickness of, e.g., not less than 30 μm and not more than 70 μm. In the first embodiment, the thickness of the copper layer 4 is 50 μm.

Next, heat exchange mechanism of the heat pipe 10 will be described. When the heat absorbing portion 101 of the heat pipe 10 is heated by exhaust gas from the engine 90, the heat is absorbed from the outer peripheral surface of the base material 2 of the heat absorbing portion 101. The absorbed heat is transferred through the base material 2, the nickel layer 3 and the copper layer 4 in a thickness direction, thereby heating the water 5 which is in contact with the surface 4a of the copper layer 4. The heated water 5 becomes steam (vapor phase) and moves upward inside the heat pipe 10.

Since the heat radiating portion 102 is maintained at a lower temperature than the heat absorbing portion 101 by the cooling water for the engine 90, the steam moved to the upper portion of the storage space 10a comes into contact with the surface 4a of the copper layer 4 in the heat radiating portion 102, is condensed and thereby turns back into water (liquid phase). At this stage, heat is transferred from the steam to the copper layer 4.

The heat transferred to the copper layer 4 is transferred through the copper layer 4, the nickel layer 3 and the base material 2 in the thickness direction and is radiated from the outer peripheral surface of the base material 2. The cooling water for the engine 90 is thereby heated.

The water produced by condensation of steam moves downward along the surface 4a of the copper layer 4 due to gravity, is reheated in the heat absorbing portion 101 and becomes steam which moves upward again. The heat exchanger 1 performs heat exchange by repeating this process and heats the cooling water using the heat absorbed from the exhaust gas.

Method of Manufacturing the Heat Pipe 10

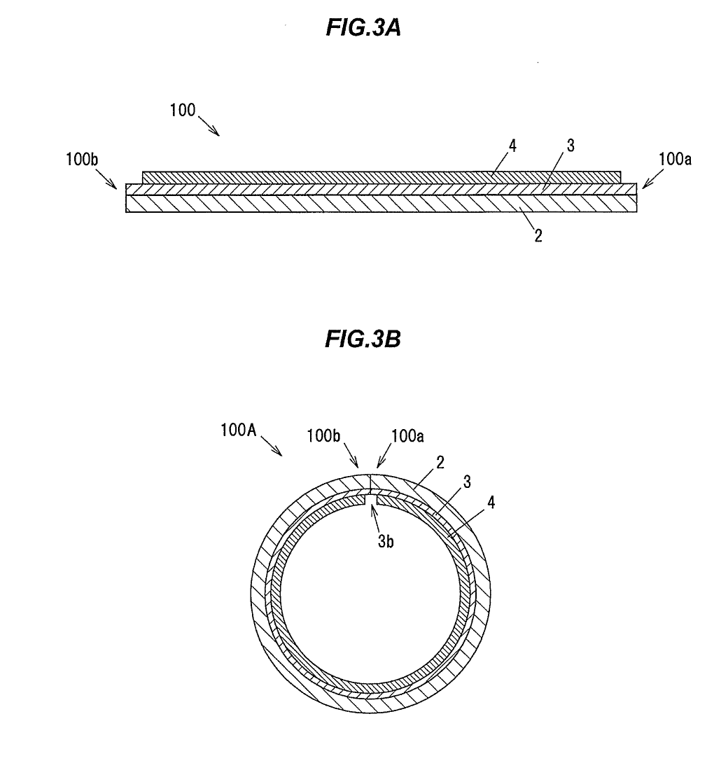

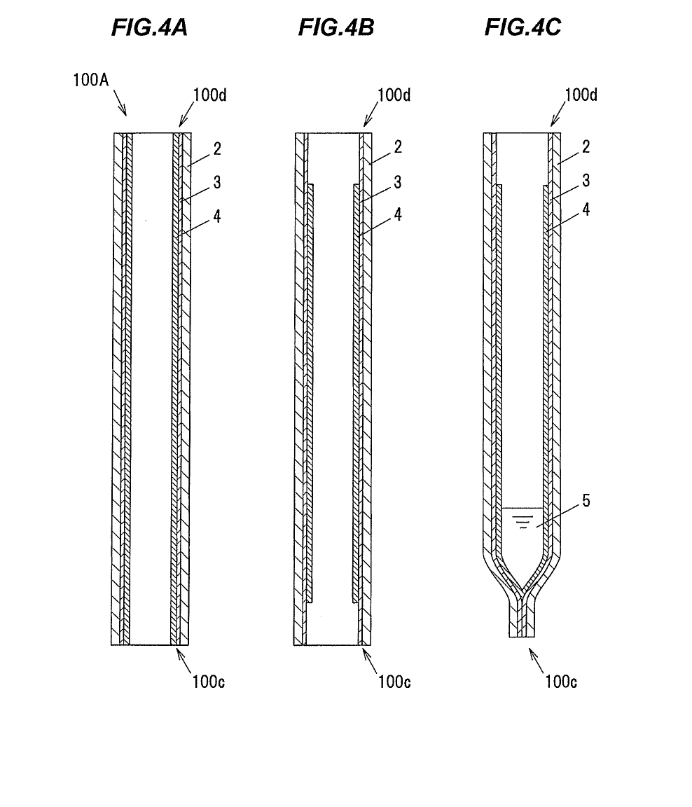

Next, a method of manufacturing the heat pipe 10 will be described in reference to FIGS. 3A to 4C.

FIGS. 3A and 3B show a manufacturing process of the heat pipe 10, wherein

FIG. 3A is a cross sectional view showing a plate-like member before being formed into a cylindrical shape and FIG. 3B is a cross sectional view showing the plate-like member after being formed into a cylindrical base pipe.

Firstly, in the manufacturing process of the heat pipe 10, three sheet materials which are a stainless steel sheet, a nickel sheet and a copper sheet are stacked and pressure-welded by rolling (bond rolling), and then, the pressure-welded three-layer metal sheet is diffusion-annealed and is further rolled. This provides a plate-like member 100 constructed from a clad material in which the nickel layer 3 is formed on a surface of the plate-like base material 2 and the copper layer 4 is further formed on a surface of the nickel layer 3 (a surface opposite to the base material 2) as shown in FIG. 3A. Here, the clad material means a metal material in which dissimilar metals are diffusion-bonded at boundary surfaces. In addition, the plate-like member 100 is an example of a composite material for heat pipe of the invention.

A copper raw material used for forming the copper layer 4 is preferably pure copper (copper having a purity of not less than 99.9 mass %, conforming to JIS H3100).

In addition, a nickel raw material used for forming the nickel layer 3 is preferably pure nickel (nickel having a purity of not less than 99 mass %).

The plate-like member 100 has a rectangular shape and FIG. 3A shows a cross section of the plate-like member 100 orthogonal to a longitudinal direction thereof. A width of the copper layer 4 in a lateral direction of the plate-like member 100 (a horizontal direction in FIG. 3A) is smaller than those of the base material 2 and the nickel layer 3 in the same direction. Thus, a region in which the surface of the nickel layer 3 is not covered with the copper layer 4 is present at a lateral end portion 100a and another lateral end portion 100b of the plate-like member 100.

Next, in the manufacturing process of the heat pipe 10, the plate-like member 100 is curved along the lateral direction thereof, the end portion 100a and the other end portion 100b facing each other are welded to each other and a cylindrical base pipe 100A is thereby formed. An exposed portion 3b of the nickel layer 3 formed due to absence of the copper layer 4 is present in the base pipe 100A. The presence of the exposed portion 3b prevents copper of the copper layer 4 from getting into the welded portion at the time of welding the end portion 100a to the other end portion 100b, which allows strength of the heat pipe 10 to be maintained.

FIGS. 4A to 4C show a manufacturing process of the heat pipe 10, wherein FIG. 4A is a cross sectional view showing the base pipe 100A including a central axis and

FIGS. 4B and 4C are cross sectional views showing a state that the base pipe 100A shown in FIG. 4A is processed.

In a step of processing the base pipe 100A into the heat pipe 10, the copper layer 4 is partially removed in the vicinity of a longitudinal end portion 100c and another longitudinal end portion 100d of the base pipe 100A, as shown in FIG. 4B. As the method of removing the copper layer 4, it is possible to use, e.g., etching using nitric acid.

Next, as shown in FIG. 4C, the end portion 100c of the base pipe 100A is swaged and welded and the water 5 is poured into the base pipe 100A. Substantially, the position is maintained such that the end portion 100c is located on the vertically lower side and the other end portion 100d of the base pipe 100A is then swaged and welded while evacuating the air. Since the copper layer 4 is removed at the end portion 100c and the other end portion 100d, it is possible to reliably perform welding of the end portion 100c and welding of the other end portion 100d. The heat pipe 10 shown in FIG. 2A is thereby obtained.

Steam Oxidation Test

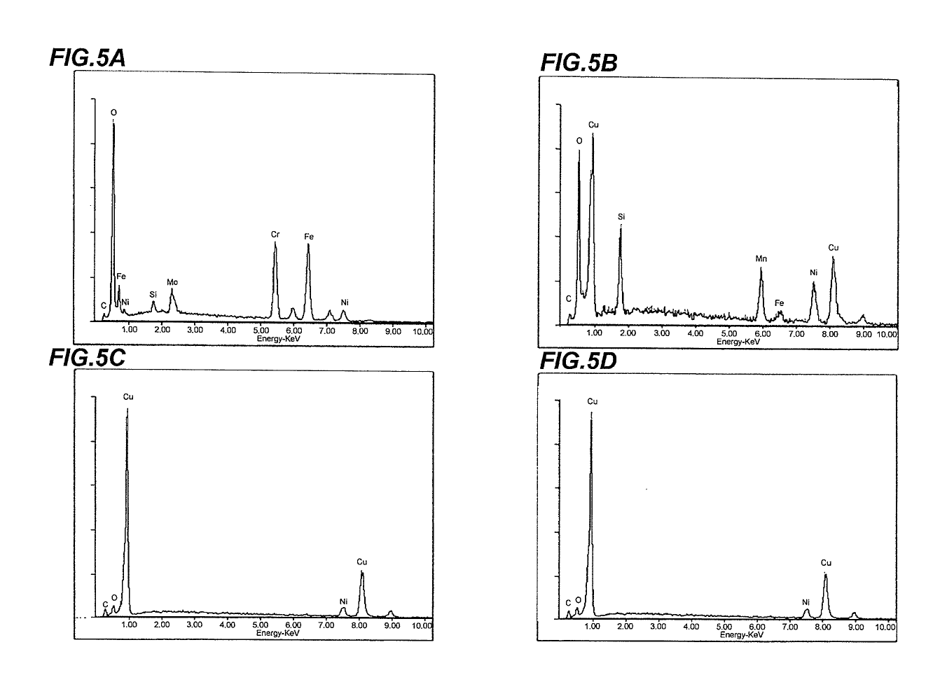

Next, the results of steam oxidation test conducted to verify the effects of the first embodiment will be described in reference to FIGS. 5A to 5D.

FIGS. 5A to 5D are EDX (energy dispersive X-ray fluorescence analyzer) spectra showing results of steam oxidation test conducted on below-described first to fourth samples.

FIG. 5A is an EDX spectrum of the first sample which is stainless steel (SUS316L). FIG. 5B is an EDX spectrum of the second sample which is stainless steel (EM-3, manufactured by Nisshin Steel Co., Ltd.). FIG. 5C is an EDX spectrum of the third sample which is a clad material formed by pressure-welding cupronickel (white copper) containing 30% nickel in base copper to stainless steel (EM-3). FIG. 5D is an EDX spectrum of the fourth sample which is a clad material formed by pressure-welding nickel and copper layers to a stainless steel base material (equivalent to the heat pipe 10 in the first embodiment).

In the test, the first to fourth samples were heated in an inert gas (Ar) at 1250° C. for 15 minutes and were then each cut into 6 mm square. Then, the samples were encapsulated together with pure water in a quartz tube while evacuating the air, and the quartz tube was heated in a muffle furnace under the conditions of 900° C. for 1 hour. After that, the quartz tube was taken out of the muffle furnace and was air-cooled, and subsequently, each sample was taken out and oxidation degree of the surface thereof was analyzed by SEM/EDX quantitative analysis. It should be noted that heating at 1250° C. for 15 minutes was performed to simulate the welding of both end portions of the heat pipe 10.

As shown in FIGS. 5A and 5B, a large peak indicating presence of oxygen (O) was observed in the first and second samples. It is believed that this is because an oxide of chrome (Cr) and iron (Fe) contained in stainless steel or more-easily-oxidizable metal such as niobium (Nb) was formed due to the heated steam. It should be noted that the inventers have confirmed that fine chrome oxide (CrO) is formed on the surface of stainless steel in case of oxidation in the air and exerts an effect of preventing further oxidation but such an effect is not exerted in case of steam oxidation.

As shown in FIGS. 5C and 5D, the peaks of oxygen (O) in the third and fourth samples were remarkably smaller than those in the first and second samples. The following two reasons are considered to be the main cause. Firstly, both samples have the uppermost surface formed of metal consisting mainly of copper which is less likely to be oxidized. Secondly, diffusion of easily-oxidizable metals, such as chrome (Cr) contained in the stainless steel base material, to the outermost surface is suppressed by the cupronickel layer in the third sample and the nickel and copper layers in the fourth sample.

Especially in the fourth sample, it is believed that diffusion of the easily-oxidizable metal contained in stainless steel is suppressed by the nickel layer. In other words, it is believed that the nickel layer functions as a barrier layer and suppresses oxidation of the surface.

The test results show that, in the heat pipe 10 of the first embodiment, oxidation of the inner surface due to steam at high temperature is suppressed and generation of hydrogen is thus suppressed.

As described above, in the first embodiment, oxidation of the inner surface of the heat pipe 10 under high temperature environment is suppressed by forming the nickel layer 3 on the base material 2 and further forming the copper layer 4 consisting mainly of copper on the nickel layer 3. This allows pressure rise inside the heat pipe 10 due to hydrogen generation to be suppressed. Therefore, the thickness of the base material 2 can be reduced as compared to the case of not providing the nickel layer 3 and the copper layer 4, which improves heat-exchange efficiency and also allows an increase in cost and weight to be suppressed.

### Second Embodiment

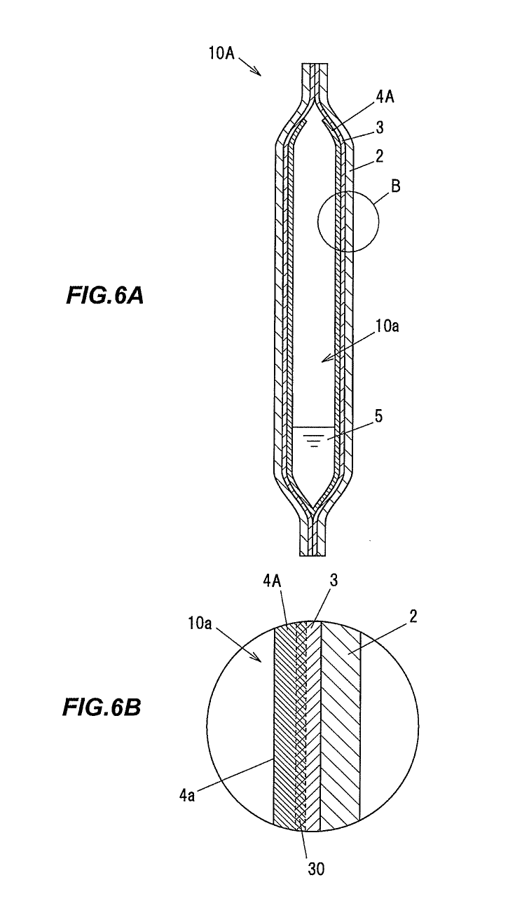

Next, the second embodiment of the invention will be described in reference to FIGS. 6A and 6B.

FIGS. 6A and 6B show a heat pipe 10A in the second embodiment of the invention, wherein FIG. 6A is a cross sectional view showing the heat pipe 10A including a central axis and FIG. 6B is an enlarged view of the section B in FIG. 6A. Constituent elements having substantially the same functions as those described in the first embodiment are denoted by the same reference numerals in FIGS. 6A and 6B and the overlapping explanation thereof will be omitted.

The heat pipe 10A has an alloy layer 4A as the second metal layer in place of the copper layer 4 of the first embodiment. The alloy layer 4A consists mainly of a copper-nickel alloy. A gradient composition layer 30, in which nickel content decreases toward the alloy layer 4A, is formed between the nickel layer 3 and the alloy layer 4A.

Nickel is substantially uniformly distributed in the alloy layer 4A. The alloy layer 4A is formed of, e.g., cupronickel containing 10 to 30 mass % of nickel. That is, the third sample in the steam oxidation test is an equivalent to the heat pipe 10A in the second embodiment.

For forming the alloy layer 4A, for example, diffusion annealing of the above-mentioned manufacturing method is performed at higher temperature than that for manufacturing the heat pipe 10 of the first embodiment. That is, the alloy layer 4A is a metal layer in which a nickel sheet and a copper sheet are pressure-welded to a stainless steel sheet to be the base material and are melted together by heat. During the melting, a portion of the nickel sheet on the copper sheet side is melted and is diffused into the copper sheet. Since the melting point of the copper sheet (e.g., 1083° C.) is lower than that of the nickel sheet (e.g., 1453° C.), nickel diffused into the copper sheet is substantially uniformly distributed in the copper sheet.

The second embodiment achieves the effect of suppressing oxidation of the inner surface of the heat pipe 10A and thereby suppressing pressure rise inside the heat pipe 10A in the same manner as the first embodiment, and in addition to this, since the melting point of the alloy layer 4A is higher than that of the copper layer 4 of the first embodiment, it is possible to prevent the alloy layer 4A from melting by heat and flowing downward at the time of welding one end portion and another end portion of the heat pipe 10A. Therefore, it is possible to suppress internal pressure rise more reliably.

Although the embodiments of the invention have been described, the invention according to claims is not to be limited to the above-mentioned embodiments. Further, it should be noted that all combinations of the features described in the embodiments are not necessary to solve the problem of the invention.

In addition, the invention is not limited to the first and second embodiments and can be appropriately modified without departing from the gist of the invention. For example, the heat pipes 10, 10A and the heat exchanger 1 using thereof are used not only for heat exchange between exhaust gas and cooling water in a vehicle but also for other purposes. In addition, the configuration of the heat exchanger 1 is not limited to that in the example shown in FIG. 1 and can be appropriately modified depending on the intended use, etc.

What is claimed is:

1. A heat pipe, comprising:
a metal cylindrical body comprising a sealed storage space for storing water;
a heat absorbing portion at one end portion of the cylindrical body to absorb heat by means of evaporation of the water; and
a heat radiating portion at another end portion of the cylindrical body to radiate heat by means of condensation of steam generated by the evaporation,
wherein the cylindrical body comprises a base material mainly comprising a stainless steel, a first metal layer mainly comprising a nickel and a second metal layer mainly comprising a copper, the first metal layer being formed on an inner surface of the base material and the second metal layer being formed on an inner surface of the first metal layer, and
wherein the second metal layer is exposed to the storage space.

2. The heat pipe according to claim 1, wherein the second metal layer comprises a metal layer mainly comprising a copper.

3. The heat pipe according to claim 1, wherein the second metal layer comprises a metal layer mainly comprising a copper-nickel alloy.

4. The heat pipe according to claim 3, wherein the second metal layer comprises a metal layer formed by melting nickel and copper sheets together by heat, the nickel and copper sheets being pressure-welded to a stainless steel sheet to be the base material.

5. A composite material for heat pipe, comprising:
a base material mainly comprising a stainless steel;
a first metal layer mainly comprising a nickel and formed on the base material; and
a second metal layer mainly comprising a copper and formed on the first metal layer,
wherein the composite material is configured to be used for a heat pipe that comprises a metal cylindrical body comprising a sealed storage space for storing water,
a heat absorbing portion at one end portion of the cylindrical body to absorb heat by means of evaporation of the water, and a heat radiating portion at another end portion of the cylindrical body to radiate heat by means of condensation of steam generated by the evaporation.

6. A heat exchanger, comprising a plurality of ones of the heat pipe according to claim 1, wherein the plurality of ones of the heat pipe each comprise one end portion located inside an exhaust gas passage, another end portion located inside a cooling water passage, and water enclosed at the one end portion thereof.
